(19) United States
(12) Patent Application Publication
(10) Pub. No.: US 2010/0070151 A1
(43) Pub. Date: Mar. 18, 2010

(54) Vehicle Speed Control Device and Method for Controlling Vehicle Speed

(75) Inventors: Hiroki Sonoda, Atsugi-shi (JP); Motohiro Higuma, Atsugi-shi (JP); Akira Takahashi, Isehara-shi (JP); Jun Kubo, Hino-shi (JP); Toshiya Oosawa, Yokohama-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Automotive Systems, Ltd., Hitachinaka-shi (JP)

(21) Appl. No.: 12/560,896

(22) Filed: Sep. 16, 2009

(30) Foreign Application Priority Data
Sep. 17, 2008 (JP) 2008-238153

(51) Int. Cl. G06F 19/00

(52) U.S. Cl. 701/96

(57) ABSTRACT

An accelerator pedal operation condition detecting section detects an operation condition of the accelerator pedal, a brake pedal operation condition detecting section detects an operation condition of the brake pedal; an inter-vehicular distance detecting section detects a distance between an own-vehicle and a forward-vehicle and a speed control section controls a speed of the own-vehicle. A control unit is configured to keep a relative positional relation between the own-vehicle and the forward-vehicle when the detected inter-vehicular distance is smaller than a predetermined reference inter-vehicular distance and the operation condition detected by the accelerator pedal operation condition detecting section and the brake pedal operation condition detecting section indicates a predetermined operation condition.

### BACKGROUND OF THE INVENTION

1. Field of the Invention

The present invention relates in general to a device and method for controlling a vehicle speed, and more particularly to a device and method for controlling the vehicle speed in such a manner as to keep a relative speed of the vehicle to another vehicle ahead within a predetermined range.

2. Description of the related Art

One of the above-mentioned speed control devices is disclosed in Japanese Laid-open Patent Application (tokkai) 2007-238031. In the disclosed device, when an accelerator pedal kept is depressed (viz., accelerator ON operation) is released or turned OFF (viz., accelerator OFF operation), a distance (viz., inter-vehicular distance) between the vehicle (viz., own-vehicle) and a vehicle ahead (viz., forward-vehicle) is detected and determined as a so-called target inter-vehicular distance, and if an actual inter-vehicular distance between the two vehicles becomes smaller than the target inter-vehicular distance, the speed of the vehicle is automatically reduced.

### SUMMARY OF THE INVENTION

In the above-mentioned known speed control device, when a driver wants to increase the target inter-vehicular distance under the speed control, it is necessary for the driver to depress a brake pedal to reduce the vehicle speed, and when the actual inter-vehicular distance becomes a desired inter-vehicular distance, the driver has to carry out a series of ON and OFF operation of an accelerator pedal, that is, the driver has to depress the accelerator pedal and then release the same. As is easily understood, such series of ON and OFF operation of the accelerator pedal needed by the driver under the speed control lacks ease-of-use of the speed control device.

In other words, in the above-mentioned known speed control device, a so-called “intervention by driver” is substantially impossible at the time when the vehicle is under a speed control. That is, intervention to the speed control by the driver is substantially impossible in the known speed control device.

Accordingly, it is an object of the present invention to provide a vehicle speed control device and method for controlling the vehicle speed, which are free of the above-mentioned drawback.

That is, it is an object of the present invention to provide a vehicle speed control device and method for controlling the vehicle speed, which allow a driver to easily make an intervention to the vehicle speed control when it is needed.

In accordance with a first aspect of the present invention, there is provided a vehicle speed control device of a motor vehicle with an accelerator pedal and a brake pedal, which comprises an accelerator pedal operation condition detecting section that detects an operation condition of the accelerator pedal; a brake pedal operation condition detecting section that detects an operation condition of the brake pedal; an inter-vehicular distance detecting section that detects a distance between an own-vehicle and a forward-vehicle; a speed control section that controls a speed of the own-vehicle; and a control unit that is configured to keep a relative positional relation between the own-vehicle and the forward-vehicle when the detected inter-vehicular distance is smaller than a predetermined reference inter-vehicular distance and the operation condition detected by the accelerator pedal operation condition detecting section and the brake pedal operation condition detecting section indicates a predetermined operation condition.

In accordance with a second aspect of the present invention, there is provided a speed control device of a motor vehicle with an accelerator pedal and a brake pedal, which comprises an accelerator pedal operation condition detecting section that detects a first situation in which a depression degree of the accelerator pedal is reduced; a brake pedal operation condition detecting section that detects a second situation in which a depression degree of the brake pedal is reduced; an inter-vehicular distance detecting section that detects a distance between a forward-vehicle and the own-vehicle, a brake section that is able to reduce a speed of a prime mover of the own-vehicle and a speed of road wheels of the own-vehicle; a forward-vehicle speed detecting section that detects a speed of a forward-vehicle; an own-vehicle speed detecting section that detects a speed of the own-vehicle; a speed control section that controls a speed of the own-vehicle; a control unit that is configured to control operation of the prime mover and that of the brake section to control a relative speed between the two vehicles when at least one of the accelerator pedal operation condition detecting section and the brake pedal operation condition detecting section detects a reduction in depression degree of the corresponding pedal and the detected inter-vehicular distance is smaller than a predetermined reference inter-vehicular distance.

In accordance with a third aspect of the present invention, there is provided a method of controlling a speed of a motor vehicle that has an accelerator pedal, a brake pedal and a speed control section, which comprises in steps detecting an operation condition of the accelerator pedal; detecting an operation condition of the brake pedal; detecting an inter-vehicular distance between an own-vehicle and a forward-vehicle; and keeping a relative positional relation between the two vehicles when the detected inter-vehicular distance is smaller than a predetermined reference inter-vehicular distance and the detected operation condition of the accelerator pedal and the brake pedal indicates a predetermined operation condition.

### BRIEF DESCRIPTION OF THE DRAWINGS

Other objects and advantages of the present invention will become apparent from the following description when taken in conjunction with the accompanying drawings, in which:

FIG. 1 is a schematic view of a vehicle speed control device of the present invention which is practically applied to a four-wheel motor vehicle;

FIG. 2 is a flowchart depicting an outline of programmed operation steps that are executed in a brake control unit employed in the vehicle speed control device of the invention;

FIG. 3 is a graph showing a relation between a relative speed “Vr0” between two vehicles and an intervention maximum distance “Dvr_max”;

FIG. 4 is a graph showing a relation between the relative speed “Vr0” between the two vehicles and an intervention minimum distance “Dvr_min”;

FIG. 5 is a flowchart depicting programmed operation steps executed for calculating a target vehicle speed;

FIG. 6 is a flowchart depicting programmed operation steps executed for calculating a target vehicle speed correction term “Vco”;

FIG. 7 is a graph showing a relation between a relative speed “Vr” between two vehicles and a distance correction term “Dco”;

FIG. 8 is a flowchart depicting programmed operation steps executed for calculating target vehicle speed correction terms “Vco” for various conditions;

FIG. 9 is a graph showing a relation between a distance deviation “De” and the target vehicle speed correction term “Vco”;

FIG. 10 is a time chart depicting transition of various signals used for controlling the vehicle speed at the time when an accelerator pedal is subjected to an ON to OFF change;

FIG. 11 is a time chart depicting transition of various signals used for controlling the vehicle speed at the time when a brake pedal is subjected to an ON to OFF change;

FIG. 12 is a time chart depicting transition of various signals used for controlling the vehicle speed at the time when a forward-vehicle (viz., vehicle ahead) accelerates;

FIG. 13 is a time chart depicting transition of various signals used for controlling the vehicle speed at the time when the forward-vehicle (viz., vehicle ahead) decelerates;

FIG. 14 is a time chart depicting transition of various signals used for controlling the vehicle speed at the time when the forward-vehicle (viz., vehicle ahead) stops;

FIG. 15 is a time chart depicting transition of various signals used for controlling the vehicle speed at the time when a third vehicle gets into a space between the vehicle (viz., own-vehicle) and the forward-vehicle (viz., vehicle ahead);

FIG. 16 is a flowchart depicting programmed operation steps executed in a modification of the speed control device of the invention at the time when an accelerator open degree discriminating logic is carried out;

FIG. 17 is a graph showing a relation between an accelerator open degree, a variation of accelerator pedal depression degree and an accelerator OFF timer, practically used for carrying out the accelerator open degree discriminating logic in the modification of the speed control device of the invention; and

FIG. 18 is a time chart depicting change of the accelerator OFF timer in the modification of the speed control device of the invention at the time when an accelerator pedal that has been kept released is depressed.

### DETAILED DESCRIPTION OF PREFERRED EMBODIMENTS

In the following, a vehicle speed control device and method of controlling a vehicle speed, according to the present invention, will be described in detail with reference to the accompanying drawings.

For ease of description and understanding, a vehicle on which the vehicle speed control device of the invention is mounted will be referred to “own-vehicle” and a vehicle (or obstacle) ahead of the own-vehicle will be referred to “forward-vehicle” in the following description.

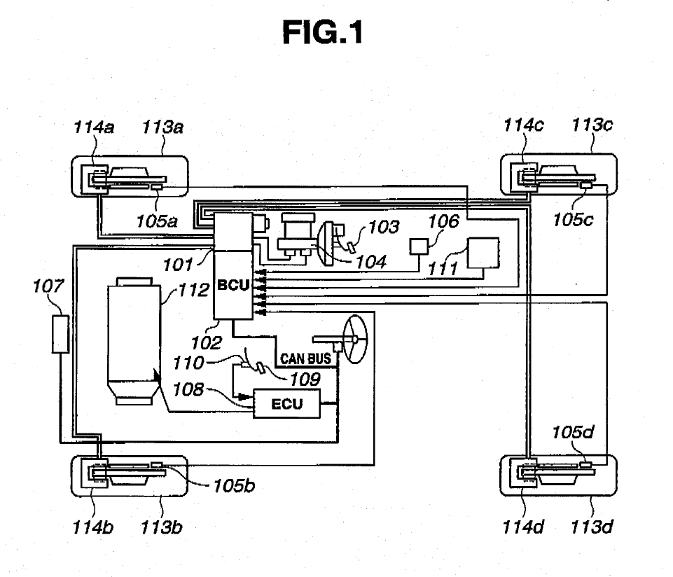

Referring to FIG. 1, there is schematically shown a vehicle speed control device of the present invention, which is practically mounted on a four-wheel motor vehicle which is the own-vehicle.

In the drawing, denoted by numeral 101 is a brake liquid pressuring unit which, upon receiving instruction signals from a brake control unit (BCU) 102, controls a hydraulic pressure fed to each of brake cylinders 114a, 114b, 114c and 114d of four road wheels 113a, 113b, 113c and 113d of the vehicle. The four road wheels are front-right, front-left, rear-right and rear-left road wheels as is understood from the drawing with respect to the orientation of a steering wheel. Brake liquid pressuring unit 101 and brake control unit 102 constitute a so-called brake device that, for braking the vehicle, controls the hydraulic pressure fed to each of brake cylinders 114a, 114b, 114c and 114d.

The brake control unit 102 carries out a so-called “speed control intervention judgment” and “target longitudinal acceleration calculation” based on information signals from a brake master cylinder pressure sensor 104, four road wheel speed sensors 105a, 105b, 105c and 105d, a speed control ON/OFF switch 106, a forward vehicle detecting camera 107, an engine control unit (ECU) 108 and a longitudinal acceleration sensor 111.

As will be explained in detail hereinafter, the camera 107 is constructed to help detecting a distance (viz., inter-vehicular distance) between the own-vehicle and a vehicle (or forward-vehicle) ahead of the own-vehicle and a speed of the forward-vehicle.

Denoted by numeral 103 is a brake pedal that is depressed by a driver when he or she wants to brake the vehicle. Master cylinder pressure sensor 104 senses a hydraulic pressure exerted in a master cylinder incorporated with brake pedal 103.

Four road wheel speed sensors 105a, 105b, 105c and 105d detect respective speeds of the front-right, front-left, rear-right and rear-left road wheels 113a, 113b, 113c and 113d.

The speed control ON/OFF switch 106 is a manual switch manually controlled by a driver. That is, by manipulating the switch 106, the speed control is turned ON or OFF.

Forward vehicle detecting camera 107 is constructed to help detecting both an inter-vehicular distance (viz., vehicle-to-vehicle distance) between the own-vehicle on which the camera 107 is mounted and the forward-vehicle and a traveling speed of the forward-vehicle. Information signals on the inter-vehicular distance and the traveling speed of the forward-vehicle are fed to the brake control unit 102 via CAN communication (viz., controller area network).

Denoted by numeral 110 is an accelerator open degree sensor 110 that senses a depression degree of an accelerator pedal.

It is to be noted that when the accelerator pedal is completely released, the accelerator open degree sensor 110 issues 0%-representing signal and when the accelerator pedal is fully depressed, the sensor 110 issues 100%-representing signal.

By processing information signals sent from accelerator open degree sensor 110, engine control unit 108 controls operation of an engine 112 so that the engine 112 outputs an engine torque in accordance with the depression degree of an accelerator pedal 109. Upon receiving through the CAN communication a request signal for a target engine torque from brake control unit 102, engine control unit 108 controls the engine 112 to output an engine torque in accordance with a target longitudinal acceleration.

When it is needed to accelerate the vehicle, the driver further depresses accelerator pedal 109. Accelerator open degree sensor 110 detects a degree by which accelerator pedal 109 is depressed. Longitudinal acceleration sensor 111 detects an acceleration of the vehicle in a longitudinal direction, viz., in a fore-and-aft direction.

The above-mentioned brake control unit 102 and engine control unit 108 are each a microcomputer that comprises CPU is (central processing unit), RAM (random access memory), ROM (read only memory) and Input and Output interfaces.

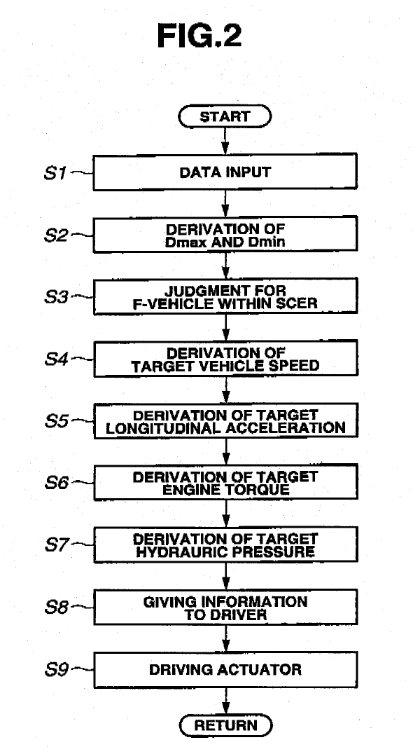

Referring to FIG. 2, there is shown a flowchart depicting an outline of programmed operation steps that are executed by brake control unit 102. These steps are repeatedly executed at a predetermined period.

At step S1, a data input treatment is carried out. That is, information signals from brake master cylinder pressure sensor 104, four road wheel speed sensors 105a, 105b, 105c and 105d, speed control ON/OFF switch 106, forward vehicle detecting camera 107, engine control unit 108 and longitudinal acceleration sensor 111 are inputted. By processing these information signals, ON/OFF condition of brake pedal 103, speeds of the four road wheels 113a, 113b, 113c and 113d, a speed “Vi” of the own-vehicle, ON/OFF condition of speed control ON/OFF switch 106, a distance “Dea” to the forward-vehicle, a speed “Vca” of the forward-vehicle and ON/OFF operation of accelerator pedal 109 (viz., accelerator) are judged or calculated and then the operation flow goes to step S2. Of course, the forward-vehicle may be a vehicle keeping a halt.

At step S2, maximum and minimum values “Dmax” and “Dmin” of the inter-vehicular distance, that permit execution of the vehicle speed control, are calculated.

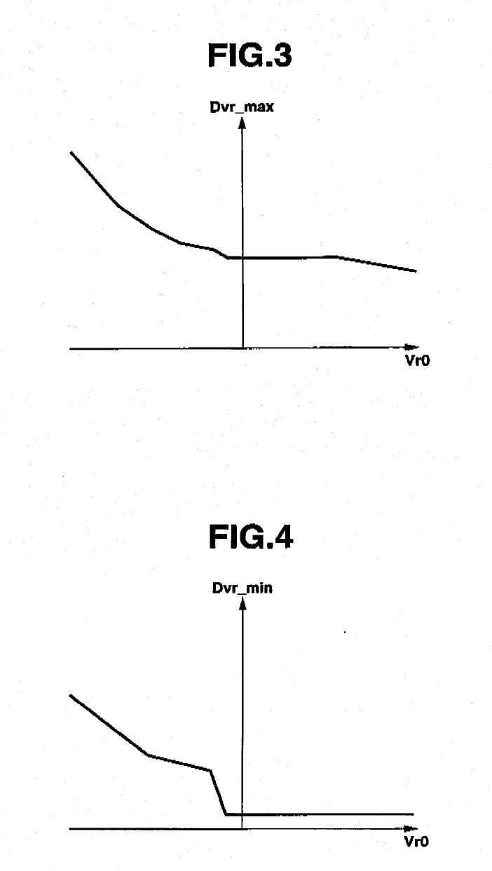

The maximum value “Dmax” is determined by selecting a higher or larger one between a value that is provided by multiplying the speed “Vi” of the own-vehicle by a predetermined maximum inter-vehicular distance “Tmax” and an intervention maximum distance “Dvr_max” that is looked up from the graph of FIG. 3. For this determination, a so-called “select high process” is practically employed.

It is to be noted that the graph of FIG. 3 shows a relation between a relative speed “Vr0” (viz., forward-vehicle speed “Vca”−own-vehicle speed “Vi”) and the intervention maximum distance “Dvr_max”.

That is, the maximum value “Dmax” is derived by the following equation (1);

Dmax=MAX(Vi×Tmax, Dvr_max) (1)

Due to the definition of the relative speed “Vr0”, when the relative speed “Vr0” shows a minus value, it means that the Speed “Vi” of the own-vehicle is higher than that “Vca” of the forward-vehicle, which brings about gradual approaching of the own-vehicle to the forward-vehicle. Thus, as the minus value of the relative speed “Vr0” increases, the distance needed by the own-vehicle for reducing the speed “Vi” to the speed “Vca” of the forward-vehicle increases, and thus, in such case, it becomes necessary to increase the value “Dmax” in accordance with the relative speed “Vr0”.

While, when the relative speed “Vr0” shows a plus value, it means that the speed “Vi” of the own-vehicle is lower than that “Vca” of the forward-vehicle, which brings about gradual receding of the own-vehicle from the forward-vehicle. Thus, as the plus value of the relative speed “Vr0” increases, the need of making the vehicle speed control for the own-vehicle becomes small, and thus, in such case, it becomes necessary to decrease the value “Dmax” in accordance with the relative speed “Vr0”.

The minimum value “Dmin” of the inter-vehicular distance is determined by selecting a higher or larger one between a value that is provided by multiplying the speed “Vi” of the own-vehicle by a predetermined minimum inter-vehicular distance “Tmin” and an intervention minimum distance “Dvr_min” that is looked up from the graph of FIG. 4.

It is to be noted that the graph of FIG. 4 shows a relation between the relative speed “Vr0” (viz., forward-vehicle speed “Vca”−own-vehicle speed “Vi”) and the intervention minimum distance “Dvr_min”.

That is, the minimum value “Dmin” is derived by the following equation (2):

Dmin=MAX (Vi×Tmin, Dvr_min) (2)

Due to the definition of the relative speed “Vr0”, when the relative speed “Vr0” shows a minus value, it means that the speed “Vi” of the own-vehicle is higher than that “Vca” of the forward-vehicle, which brings about gradual approaching of the own-vehicle to the forward-vehicle. Thus, as the minus value of the relative speed “Vr0” increases, the distance needed by the own-vehicle for reducing the speed “Vi” to the speed “Vca” of the forward-vehicle increases, and thus, in such case, it becomes necessary to increase the value “Dmin” in accordance with the relative speed “Vr0”.

Then, the operation flow goes to step S3. At this step S3, based on a distance “Dca” to the forward-vehicle that has been detected by forward vehicle detecting camera 107, judgment is carried out as to whether the forward-vehicle is placed within a speed control executing range (viz., SCER) or not.

That is, the following inequality is practically carried out:

Dmin≦Dca≦Dmax (3)

That is, when the inequality (3) is satisfied, it is judged that the forward-vehicle is placed in the speed control executing range, then, the operation flow goes to step S4.

At step S4, a so-called “target vehicle speed calculation process” is carried out for calculating a target vehicle speed correction term “Vco” and a target vehicle speed “Vtgt”. The detail of this target vehicle speed calculation process will be described hereinafter. Then, the operation flow goes to step S5.

At step S5, based on the target vehicle speed correction term “Vco” and the target vehicle speed “Vtgt” that have been provided at step S4, a target longitudinal acceleration “atgt” is derived by using the following equation.

atgt=k×(Vi−Vtgt)²/(2×|Dco|) (4)

If the relative speed “Vr” shows a plus value, the value “k” takes 1 and if the relative speed “Vr” shows a minus value, the value “k” takes −1. The target longitudinal acceleration “atgt” is set to be a value between a variable maximum value and a variable minimum value. It is to be noted that the relative speed “Vr” of equation (4) is the value derived at step S4 where the target vehicle speed calculation process is carried out. Then, the operation flow goes to step S6.

At step S6, based on the target longitudinal acceleration “atgt” derived at step S5, a target engine torque “ETtgt” is derived and then the operation flow goes to step S7.

At step S7, based on the target engine torque “ETtgt” derived at step S6, a target hydraulic pressure “Ptgt” is derived and then the operation flow goes to step S8.

At step S8, in case wherein at step S3 it has been judged that there appears a forward-vehicle against which the speed control of the own-vehicle is necessary, a rapid deceleration is applied to the own-vehicle and at the same time an alarm indication lamp is turned ON letting the driver know that the forward-vehicle has been placed within the speed control executing range. Then, the operation flow goes to step S9. When a vehicle speed control is started, the alarm indication lamp is kept ON until the time when the vehicle speed control is finished.

At step S9, information on the target engine torque “ETtgt” derived at step S6 is led to engine control unit 108, and at the same time, for realizing the target hydraulic pressure “Ptgt” derived at step S7, brake liquid pressuring unit 101 is driven, and the operation flow goes to RETURN.

In the following, the various processes outlined in the above with the aid of the flowchart of FIG. 2 will be described in detail.

### [Target Vehicle Speed Calculation Process]:

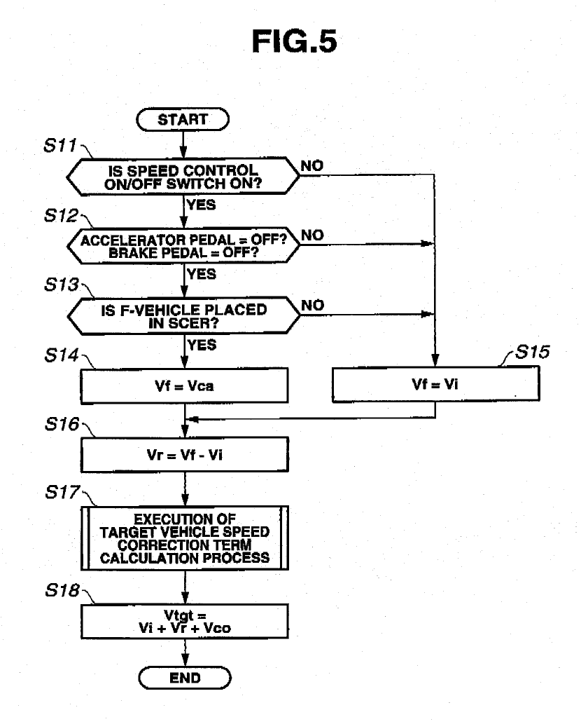

FIG. 5 is a flowchart showing the detailed operation steps possessed by the target vehicle speed calculation process.

At step S11, judgment is carried out as to whether speed control ON/OFF switch 106 is ON or not. If YES, that is, when the switch 106 is ON, the operation flow goes to step S12, while, if NO, that is, when the switch 106 is OFF, the operation flow goes to step S15.

At step S12, judgment is carried out as to whether both the accelerator pedal 109 and brake pedal 103 are in OFF condition (or released) or not. If YES, that is, when both of them are in OFF condition (or released), the operation flow goes to step S13, while, if NO, that is when at least one of them is in ON condition (or depressed), the operation flow goes to step S15.

At step S13, judgment is carried out as to whether a forward-vehicle is placed within a speed control executing range or not. If YES, that is, when the forward-vehicle is placed in the speed control executing range, the operation flow goes to step S14, while, if NO, that is, when the forward-vehicle is out of the speed control executing range, the operation flow goes to step S15.

At step S14, the speed “Vf” of the forward-vehicle is set to a value (viz., detected speed of the forward vehicle) “Vca” that has been derived by the aid of forward vehicle detecting camera 107. Then, the operation flow goes to step S16.

At step S15, the speed “Vf” of the forward-vehicle is set to the speed “Vi” of the own-vehicle. Then, the operation flow goes to step S16, as shown.

At step S16, a relative speed “Vr” of the own-vehicle to the forward-vehicle is derived from the following equation (5):

Vr=Vf−Vi (5)

Then, the operation flow goes to step S17. At this step S17, the target vehicle speed correction term calculation process is carried out for deriving the target vehicle speed correction term “Vco”. Then, the operation flow goes to step S18. The detail of the target vehicle speed correction term “Vco” will be described hereinafter.

At step S18, the target vehicle speed “Vtgt” is derived or calculated from the following equation (6) and the target vehicle speed calculation process is finished:

Vtgt=Vi+Vr+Vco (6)

### [Target Vehicle Speed Correction Term Calculation Process]:

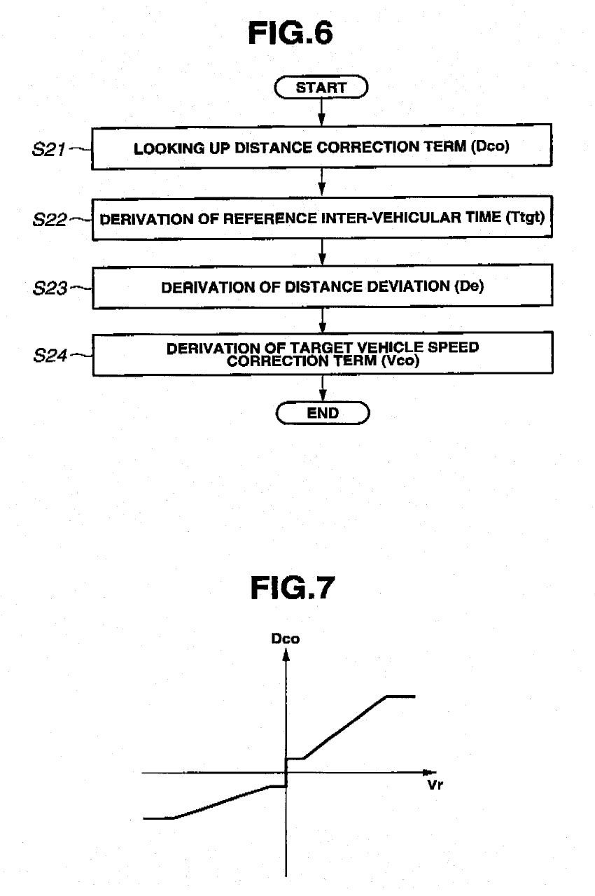

FIG. 6 is a flowchart showing the detailed operation steps possessed by the target vehicle speed correction term calculation process.

At step S21, the distance correction term “Dco” according to the relative speed “Vr” is looked up from the graph of FIG. 7. Then, the operation flow goes to step S22 which will be described hereinafter. It is to be noted that the distance correction term “Dco” is within a range between the maximum value “Dmax−Dca” and the minimum value “Dmin−Dca”.

The graph of FIG. 7 shows a relation between the relative speed “Vr” and the distance correction term “Dco”.

When the relative speed “Vr” of the own-vehicle (to the forward-vehicle) shows a plus value, it means that the speed “Vf” of the forward-vehicle is higher than that “Vi” of the own-vehicle, which brings about gradual receding of the own-vehicle from the forward-vehicle. Accordingly, in this case, acceleration of the own-vehicle is made while increasing a value of the distance “Dca” to the forward-vehicle, and thus, the distance correction term “Dco” takes a plus value. As shown, the graph of FIG. 7 is so made that when the relative speed “Vr” is higher than a given value, the distance correction term “Dco” takes a constant value. With this, enlargement of the distance correction term “Dco” is limited.

While, when the relative speed “Vr” of the own-vehicle (to the forward-vehicle) shows a minus value, it means that the speed “Vf” of the forward-vehicle is lower than the speed “Vi” of the own-vehicle, which brings about gradual approaching of the so own-vehicle to the forward-vehicle. Accordingly, in this case, deceleration of the own-vehicle is made while reducing the value of the distance “Dca” to the forward-vehicle, and thus the distance correction term “Dco” takes a minus value. As shown, the graph of FIG. 7 is so made that when the relative speed “Vr” is lower than a given value, the distance correction term “Dco” takes a constant value.

When the relative speed “Vr” is very small, the distance correction term “Dco” is determined to 0 (zero).

At step S22, a so-called reference inter-vehicular time “Ttgt” is derived from the following equation (7) and the operation flow goes to step S23:

Ttgt=(Dca+Dco)/Vi (7)

That is, the reference inter-vehicular time “Ttgt” refers to a time needed by the own-vehicle to travel an inter-vehicular distance that is produced when, upon judgment of presence of a forward-vehicle in front of the own-vehicle, the accelerator pedal operation changes from ON to OFF with the brake pedal operation kept OFF (or the brake pedal operation changes from ON to OFF with the accelerator pedal operation kept OFF).

It is to be noted that the speed “Vi” in the equation (7) is the speed of the own-vehicle at the time when the accelerator pedal operation changes from ON to OFF, the brake pedal operation changes from ON to OFF, or either of the accelerator pedal and the brake pedal are kept OFF and it is judged that a forward-vehicle has appeared in front of the own-vehicle.

At step S23, a distance deviation “De” is derived from the following equation (8):

De=Ttgt×Vi−Dca (8)

It is to be noted that the term “Vi” of the equation (8) is the speed of the own-vehicle detected at the current calculation period.

Then, the operation flow goes to step S24.

At step S24, the target vehicle speed correction term “Vco” is calculated and the target vehicle speed correction term calculation process is finished.

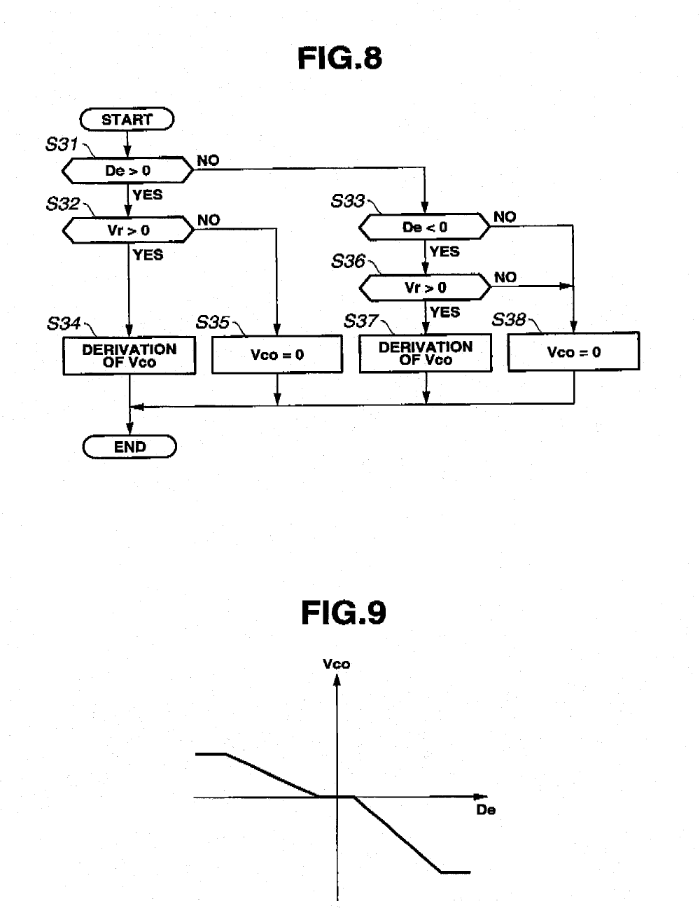

FIG. 8 is a flowchart showing the detailed operation steps possessed by the target vehicle speed correction term calculation process.

At step S31, judgment is carried out as to whether the distance deviation “De” derived at step S23 is larger than 0 (zero) or not. If YES, that is, when the distance deviation “De” is larger than 0, the operation flow goes to step S32, while, if NO, that is, when the distance deviation “De” is equal to or smaller than 0, the operation flow goes to step S33.

At step S32, judgment is carried out as to whether the relative speed “Vr” derived at step S16 is higher than 0 (zero) or is not. If YES, that is, when the relative speed “Vr” is higher than 0, the operation flow goes to step S34, while, if NO, that is, when the relative speed “Vr” is equal to or lower than 0, the operation flow goes to step S35.

At step S33, judgment is carried out as to whether the distance deviation “De” is smaller than 0 (zero) or not. If YES, that is, when the distance deviation “De” is smaller than 0, the operation flow goes to step S36, while, if NO, that is, when the distance deviation “De” is 0 (zero), the operation flow goes to step S38.

At step S34, the target vehicle speed correction term “Vco” according to the distance deviation “De” is picked up from the graph of FIG. 9.

The graph of FIG. 9 shows a relation between the distance deviation “De” and the target vehicle speed correction term “Vco”.

When the distance deviation “De” (=Ttgt×Vi−Dca) shows a plus value, it means that the current distance “Dca” from the own-vehicle to the forward-vehicle is smaller than a reference inter-vehicular distance “(Ttgt×Vi)”. For increasing the distance to the forward-vehicle, the target vehicle speed correction term “Vco” is made minus and the own-vehicle speed “Vi” is made lower than the forward-vehicle speed “Vf”.

While, when the distance deviation “De” (=Ttgt×Vi−Dca) shows a minus value, it means that the current inter-vehicular distance “Dca” is larger than the reference inter-vehicular distance “(Ttgt×Vi)”. For reducing the distance to the forward-vehicle, the target vehicle speed correction term “Vco” is made plus and the own-vehicle speed “Vi” is made higher than the to forward-vehicle speed “Vf”.

At step S35, the target vehicle speed correction term “Vco” is set to 0 (zero).

At step S36, judgment is carried out as to whether the relative speed “Vr” is higher than 0 (zero) or not. If YES, that is, when the relative speed “Vr” is higher than 0, the operation flow goes to step S37, while if NO, that is, when the relative speed “Vr” is 0, the operation flow goes to step S38.

At step S37, the target vehicle speed correction term “Vco” according to the distance deviation “De” is looked up from the graph of FIG. 9.

At step S38, the target vehicle speed correction term “Vco” is set to 0 (zero). As is seen from the flowchart of FIG. 8, once the operation of the step S34, S35, S37 or S38 is completed, the target vehicle speed correction term calculation process is finished.

In the following, advantageous operation of the vehicle speed control device of the present invention will be described.

### [Easy Intervention by Driver Under Speed Control]

As has been mentioned hereinabove, in case of the known speed control device disclosed in Japanese Laid-open Patent Application (tokkai) 2007-238031, an inter-vehicular distance detected at the time when the accelerator pedal is turned OFF (or released) is set to a target inter-vehicular distance and when an actual inter-vehicular distance becomes smaller than the target one, the speed of the own-vehicle is reduced. Thus, if, under speed control of the vehicle by the speed control device, the driver wants to increase the target inter-vehicular distance, he or she has to decelerate the vehicle by depressing the brake pedal at first and then when the actual inter-vehicular distance becomes to a desired larger distance, he or she has to carry out a series of operation with the accelerator pedal (viz., ON to OFF operation of the accelerator). That is, when the driver intervenes in the speed control to change or adjust a positional relation between the own-vehicle and the forward-vehicle, he or she has to make ON and OFF operations to the accelerator pedal. Such ON and OFF operations to the accelerator pedal lack ease-of use of the speed control device.

While, in the speed control device of the present invention, ON to OFF operation of the accelerator pedal as well as ON to OFF operation of the brake pedal by the driver serve as a trigger for allowing the driver to intervene in the speed control, and the brake liquid pressuring unit 101 and the engine 112 are forced to work in a manner to keep a positional relation between the own-vehicle and the forward-vehicle that has been established at the time when ON to OFF operation of the accelerator pedal or ON to OFF operation of the brake pedal was detected.

Accordingly, in the present invention, for changing the positional relation between the two vehicles, it is only necessary for the driver to make ON to OFF operation to one of the brake pedal and the accelerator pedal. That is, for example, when the driver wants to increase the actual inter-vehicular distance, it is only necessary for him or her to depress the brake pedal to reduce the own-vehicle speed and release his or her foot from the brake pedal when the actual inter-vehicular distance increases to a desired distance. As is easily understood, such brake pedal manipulation by the driver is much easier than that in the above-mentioned known case wherein ON to OFF operation is needed by both the brake pedal and the accelerator pedal. In other words, in the present invention, intervention by the driver to the speed control is easily carried out as compared with that of the known speed control device.

[Following Forward-Vehicle with the Aid of Speed Feedback]

When, in the present invention, the actual inter-vehicular distance “Dca” is within the speed control executing range (viz., between the maximum and minimum values “Dmax” and “Dmin”), the target vehicle speed “Vtgt” is calculated as is mentioned in the section of step S18 of the flowchart of FIG. 5. That is, the target vehicle speed “Vtgt” is derived by adding the own-vehicle speed “Vi”, the relative speed “Vr” and the target vehicle speed correction term “Vco” that are detected or prepared at the time when either one of the brake pedal and the accelerator pedal is turned from ON condition to OFF condition.

When, in case of deriving the target vehicle speed “Vtgt”, the distance deviation “De” shows a plus value (that is, when, upon establishment of the speed control executing condition, the current inter-vehicular distance “Dca” is smaller than the reference inter-vehicular distance “(Ttgt×Vi)”), the target vehicle speed correction term “Vco” takes a minus value, while, when the distance deviation “De” shows a minus value (that is, when the current inter-vehicular distance “Dca” is larger than the reference inter-vehicular distance “(Ttgt×Vi)”, the target vehicle speed correction term “Vco” shows a plus value.

That is, when the relative speed “Vr” is 0 (zero), the target vehicle speed “Vtgt” is equal to the current own-vehicle speed “Vi”. That is, in the present invention, the target vehicle speed “Vtgt” is so calculated as to make the relative speed “Vr” 0 (zero), and thus, a so-called speed feedback control is carried out making the own-vehicle speed “Vi” coincident with the target vehicle speed “Vtgt”.

In the above-mentioned known vehicle speed control, a so-called “distance-based feedback control” is carried out wherein the inter-vehicular distance is controlled to be coincident with a target inter-vehicular distance. Thus, when the forward-vehicle stops and thus the speed thereof becomes 0 (zero), it tends to occur that an automatic stopping of the own-vehicle in accordance with the behavior of the forward-vehicle is not expected. That is, it tends to occur that a so-called forward-vehicle following control is not maintained by the own-vehicle.

While, in the present invention, when the forward-vehicle is running within the speed control executing range, the speed feedback control is carried out wherein the relative speed of the own-vehicle to the forward-vehicle is controlled to be 0 (zero). Accordingly, when the forward-vehicle stops, the own-vehicle can be stopped in accordance with the behavior of the forward-vehicle. That is, in the present invention, even when the speed of the forward-vehicle becomes 0 (zero), the forward-vehicle following control can be continued. Accordingly, the vehicle speed control device of the invention is suited to an urban area cruising of the vehicle wherein the forward-vehicle runs while repeating its stopping and starting. That is, as compared with the known speed control device that practically uses the distance feedback control, the vehicle speed control device of the present invention can be much effectively and frequently used.

Furthermore, in the present invention, the target inter-vehicular distance is not set. That is, in the invention, when the actual inter-vehicular distance is within the speed control executing range, the speed feedback control in accordance with the target vehicle speed “Vtgt” is carried out. Thus, as compared with the known speed control device that carries out the speed control based on the target inter-vehicular distance, the speed control device of the present invention exhibits superiority in both forward-vehicle following performance and control responsiveness.

In the present invention, the target inter-vehicular distance is not used for the speed control. However, in the invention, the target vehicle speed “Vtgt” is corrected by the target vehicle speed correction term “Vco” in accordance with the reference inter-vehicular distance “Ttgt×V1”, and thus, the own-vehicle can follow the forward-vehicle while reducing the inter-vehicular distance to the reference inter-vehicular distance.

### [Information on Starting of the Speed Control]

When, in the present invention, the forward-vehicle runs into the speed control executing range, the speed control is automatically started, and when the forward-vehicle runs out of the speed control executing range, the speed control is automatically ended. Such automatic starting and ending of the speed control tend to make it difficult for the driver to see or judge whether the vehicle is under the speed control or not. In view of this, in the present invention, an alarm indication lamp is used which is turned ON to let the driver know that the forward-vehicle has run into the speed control executing range.

If desired, a suitable system may be combined with the speed control device of the invention, which applies an instantaneous braking to the own-vehicle upon starting of the speed control.

### [Determination of the Speed Control Executing Range Suitable to the Own-Vehicle Speed and the Relative Speed]

In the invention, for determining the maximum and minimum values “Dmax” and “Dmin” of the inter-vehicular distance by which the speed control executing range is defined, the following calculations are carried out. That is, for deriving the “Dmax”, the own-vehicle speed “V1” is multiplied by the maximum inter-vehicular distance “Tmax”, and for deriving the “Dmin”, the own-vehicle speed “Vi” is multiplied by the minimum inter-vehicular distance “Tmin”. Thus, as the own-vehicle speed “Vi” increases, the values “Dmax” and “Dmin” increase and thus with increase of the own-vehicle speed “Vi”, the speed control executing range is shifted forward away from the own-vehicle. This means that the speed control executing range is suitably determined by the own-vehicle speed “Vi”.

Then, in the invention, the intervention distance range defined by the intervention maximum distance “Dvr_max” and the intervention minimum distance “Dvr_min” is derived in accordance with the relative speed “Vr0”. Accordingly, as the minus value of the relative speed “Vr0” increases, the values of the “Dvr_max” and the “Dvr_min” increase, and thus, with increase of the minus values of the relative speed “Vr0”, the intervention distance range is shifted forward away from the own-vehicle. This means that the intervention distance range is suitably determined by the own-vehicle speed “Vi” and the forward-vehicle speed “Vca”.

Finally, by selecting a higher or larger one between the value “Vi×Tmax” and the value “Dvr_max”, the maximum value “Dmax” of the speed control executing range is determined, and by selecting a higher or larger one between the value “Vi×Tmin” and the value “Dvr_min”, the minimum value “Dmin” of the speed control executing range is determined. Thus, the speed control executing range is suitably determined by the own-vehicle speed “Vi” and the relative speed “Vr0”.

In the following, operation of the vehicle speed control device of the present invention will be described with respect to various conditions of the vehicle.

### [When Accelerator Pedal is Depressed and Then Released]

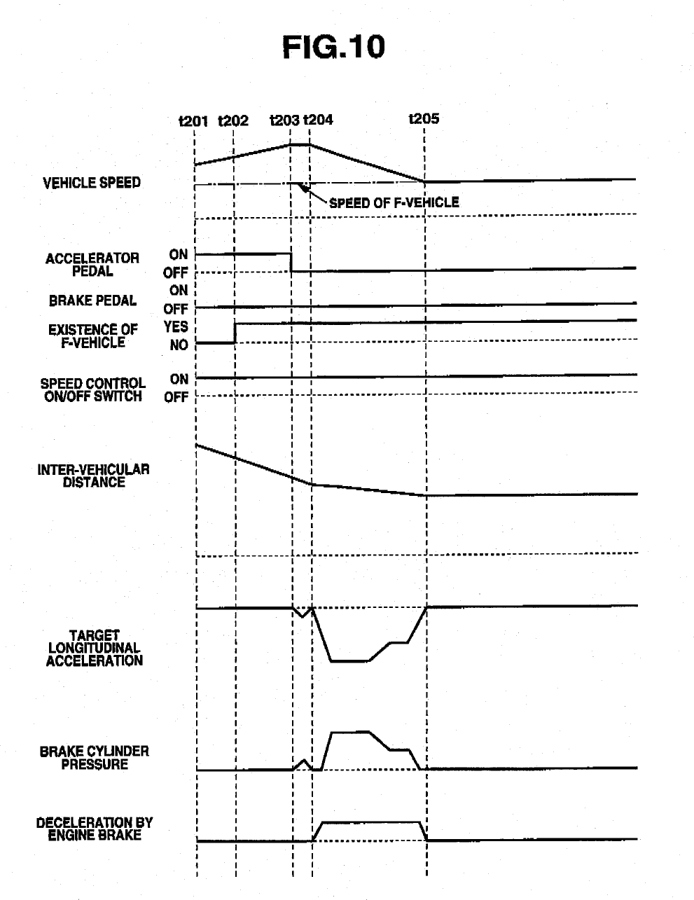

FIG. 10 is a time chart showing transition (or changes) of various factors, that appears when the accelerator pedal 109 is operated from ON to OFF condition.

At time point t201, the driver depresses the accelerator pedal 109 and thus the vehicle starts to accelerate. At time point t202, due to the acceleration of the vehicle, the distance (viz., inter-vehicular distance) to the forward-vehicle is reduced to a level of the speed control executing range (viz., Dmin≦Dco≦Dmax). Upon this, it is judged that there is a forward-vehicle in front of the own-vehicle within the speed control executing range.

At time point t203, the driver releases accelerator pedal 109 (viz., OFF operation of accelerator pedal). Upon this, an actual speed control of the own-vehicle starts. At the same time, an instantaneous braking may be given to the vehicle for letting is the driver know the start of the actual speed control of the own-vehicle.

At time point t204, a speed reduction of the own-vehicle starts because the own-vehicle speed “Vi” is higher than the forward-vehicle speed “Vf”. The speed reduction is made at first by an engine braking and then by increasing the hydraulic pressure fed to brake cylinders 114a, 114b, 114c and 114d of the four road wheels 113a, 113b, 113c and 113d.

At time point t205, the own-vehicle speed “Vi” and the forward-vehicle speed “Vf” become equal. Under this condition, there is no possibility of a collision of the own-vehicle against the forward-vehicle.

Thereafter, with the aid of a target longitudinal acceleration derived in accordance with acceleration/deceleration of the forward-vehicle, the own-vehicle follows the forward-vehicle at a speed substantially equal to the speed of the forward-vehicle.

### [When Brake Pedal ID Depressed and Then Released]

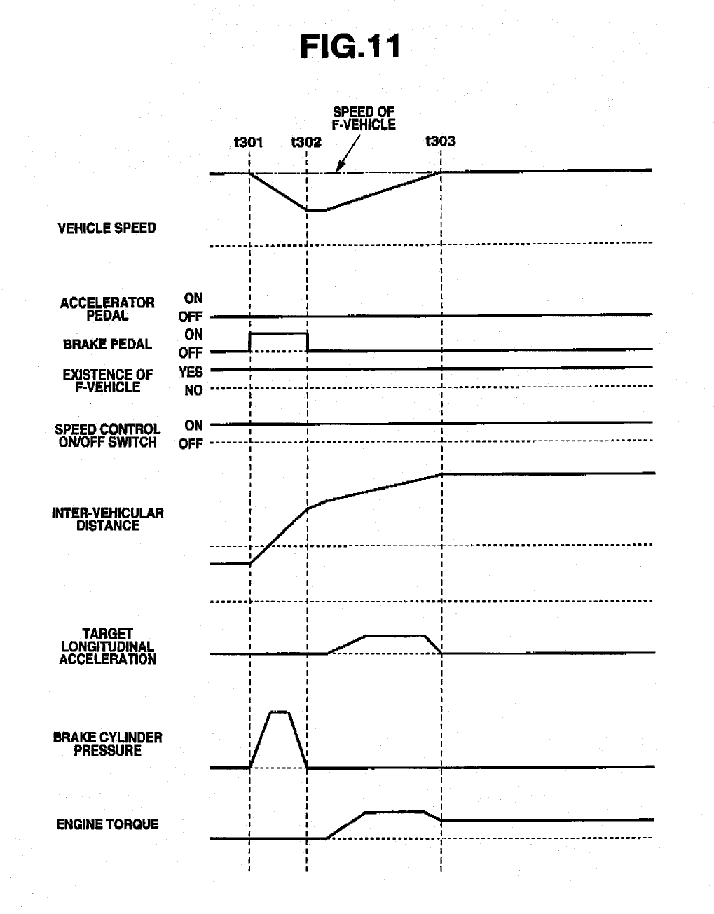

FIG. 11 is a time chart showing transition (or change) of the various factors, that appears when the brake pedal 103 is operated from ON to OFF condition.

At time point t301, the driver depresses the brake pedal 103 and thus, the vehicle starts to decelerate. Between time point t301 and time point t302, the own-vehicle Speed “Vi” is gradually reduced increasing the inter-vehicular distance.

At time point t302, the driver releases the brake pedal 103. Upon this, an actual speed control of the own-vehicle starts because it has been kept judged that a forward-vehicle is present in front of the own-vehicle. Because the own-vehicle speed “Vi” is lower than the forward-vehicle speed “Vf”, the speed of the own-vehicle is gradually increased.

At time point t303, the own-vehicle speed “Vi” and the forward-vehicle speed “Vf” become equal. Under this condition, there is no possibility of a collision of the own-vehicle against the forward-vehicle.

Thereafter, with the aid of a target longitudinal acceleration derived in accordance with acceleration/deceleration of the forward-vehicle, the own-vehicle follows the forward-vehicle at a speed substantially equal to the speed of the forward-vehicle.

### [When Forward-Vehicle Accelerates Under Speed Control of Own-Vehicle]

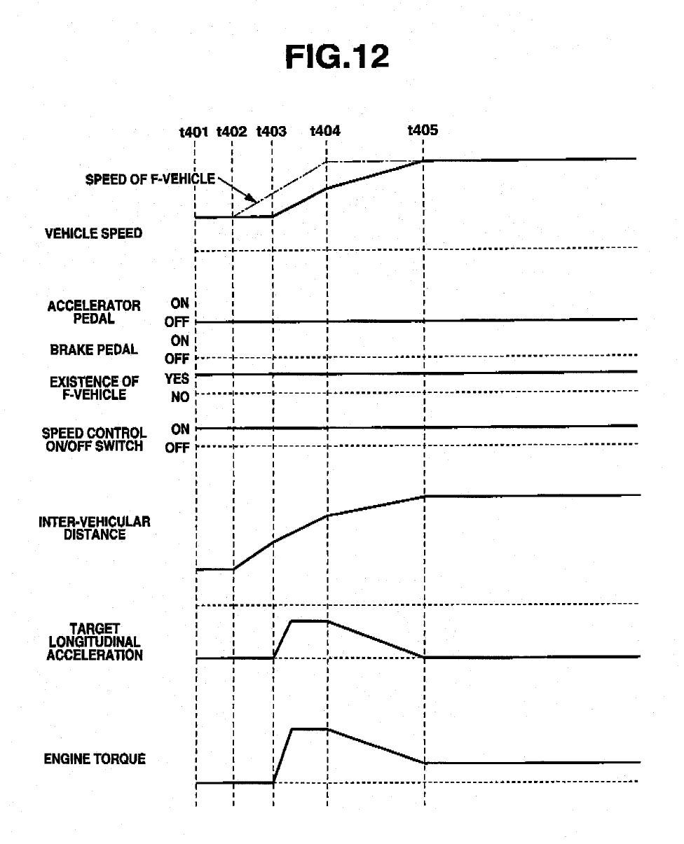

FIG. 12 is a time chart showing transition (or change) of the various factors, that appears when a forward-vehicle accelerates under the speed control of the own-vehicle.

At time point t401, both the accelerator pedal and brake pedal are kept OFF and it has been kept judged that there is a forward-vehicle in front of the own-vehicle. That is, at time point t401, an actual speed control of the own-vehicle is kept. Under this condition, the own-vehicle follows the forward-vehicle at a speed substantially equal to the speed of the forward-vehicle.

At time point t402, the forward-vehicle accelerates, and thus, at time point t403, the own-vehicle starts to accelerate in accordance with a speed difference between the two vehicles.

At time point t404, the acceleration of the forward-vehicle finishes and thus thereafter the forward-vehicle runs at a constant speed. Between time point t404 and time point t405, the speed difference between the two vehicles gradually decreases and thus, the speed control applied to the own-vehicle is so made as to gradually reduce the acceleration of the own-vehicle.

At time point t405, the own-vehicle speed “Vi” and the forward-vehicle speed “Vf” become equal, Thus, under this condition, there is no possibility of a collision of the own-vehicle against the forward-vehicle.

Thereafter, with the aid of a target longitudinal acceleration derived in accordance with acceleration/deceleration of the forward-vehicle, the own-vehicle follows the forward-vehicle at a speed substantially equal to the speed of the forward-vehicle.

### [When Forward-Vehicle Decelerates Under Speed Control of Own-Vehicle]

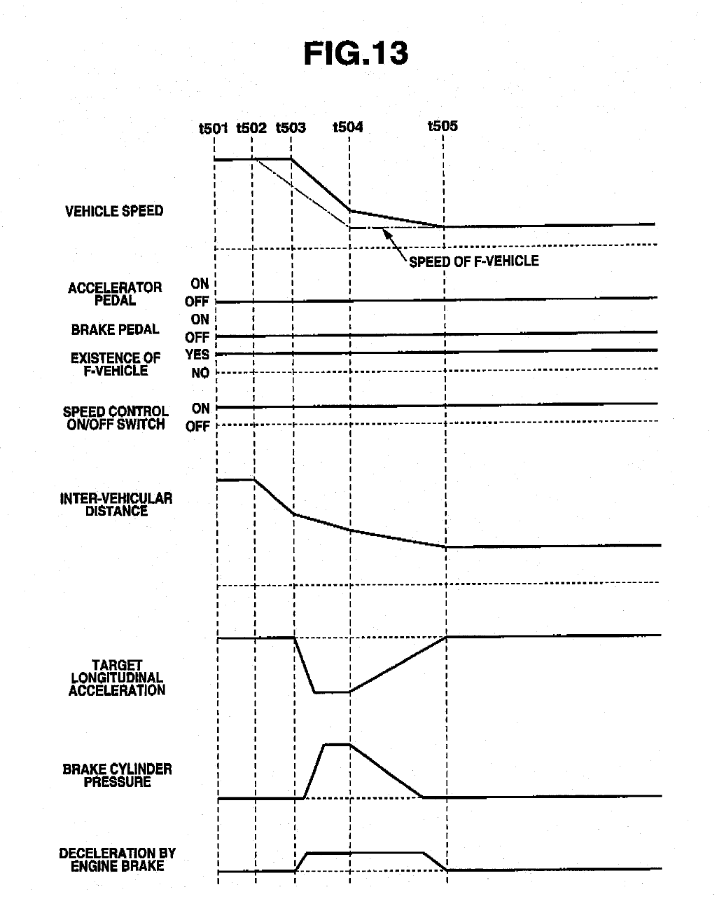

FIG. 13 is a time chart showing transition (or change) of the various factors, that appears when a forward-vehicle decelerates under the speed control of the own-vehicle.

At time point t501, both the accelerator pedal and brake pedal are kept OFF and it has been kept judged that there is a forward-vehicle in front of the own-vehicle. Thus, at time point t501, an actual speed control of the own-vehicle is kept. Under this condition, the own-vehicle follows the forward-vehicle at a speed substantially equal to the speed of the forward-vehicle.

At time point t502, the forward-vehicle decelerates, and thus, at time point t503, the own-vehicle starts to decelerate in accordance with a speed difference between the two vehicles.

At time point t504, the deceleration of the forward-vehicle finishes and thus thereafter the forward-vehicle runs at a constant speed. Between time point t504 and time point t505, the speed difference between the two vehicles gradually decreases and thus, the speed control applied to the own-vehicle is so made as to gradually reduce the deceleration of the own-vehicle.

At time point t505, the own-vehicle speed “Vi” and the forward vehicle speed “Vf” become equal. Thus, under this condition, there is no possibility of a collision of the own-vehicle against the forward-vehicle.

Thereafter, with the aid of a target longitudinal acceleration derived in accordance with acceleration/deceleration of the forward-vehicle, the own-vehicle follows the forward-vehicle at a speed substantially equal to the speed of the forward-vehicle.

### [When Forward-Vehicle is at a Stop]

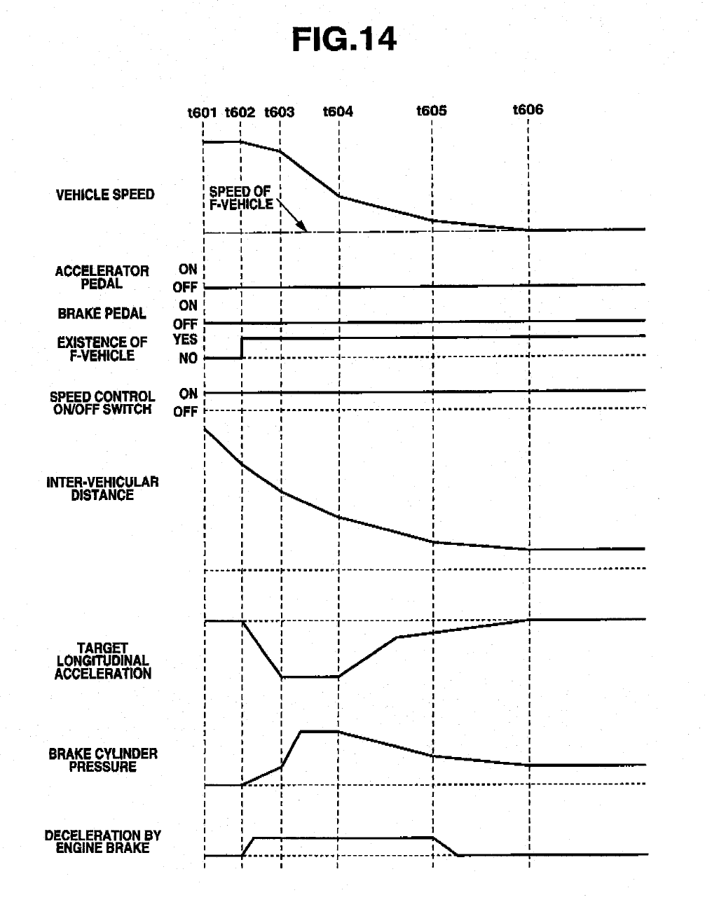

FIG. 14 is a time chart showing transition (or change) of the various factors, that appears when a forward-vehicle is at a stop.

At time point t601, the own-vehicle runs with both the accelerator pedal and brake pedal kept OFF.

At time point t602, the distance (viz., inter-vehicular distance) to the forward-vehicle becomes to a level within the speed control executing range and it has been judged that there is a forward-vehicle in front of the own-vehicle.

At this time point t602, the own-vehicle speed “Vi” is higher than the forward-vehicle speed “Vf”, and thus, the speed control for the own-vehicle starts a deceleration of the own-vehicle by the engine brake. If, under this condition, further deceleration of the own-vehicle is needed, the hydraulic pressure in each of the brake cylinders 114a, 114b, 114c and 114d of four road wheels 113a, 113b, 113c and 113d is increased to decelerate the vehicle.

At time point t606, the own-vehicle stops. Even after the time point t606, a certain hydraulic pressure is kept in each of the brake cylinders for preventing movement of the own-vehicle.

[When Third Vehicle Gets into Space Between Forward- and Own-Vehicles]

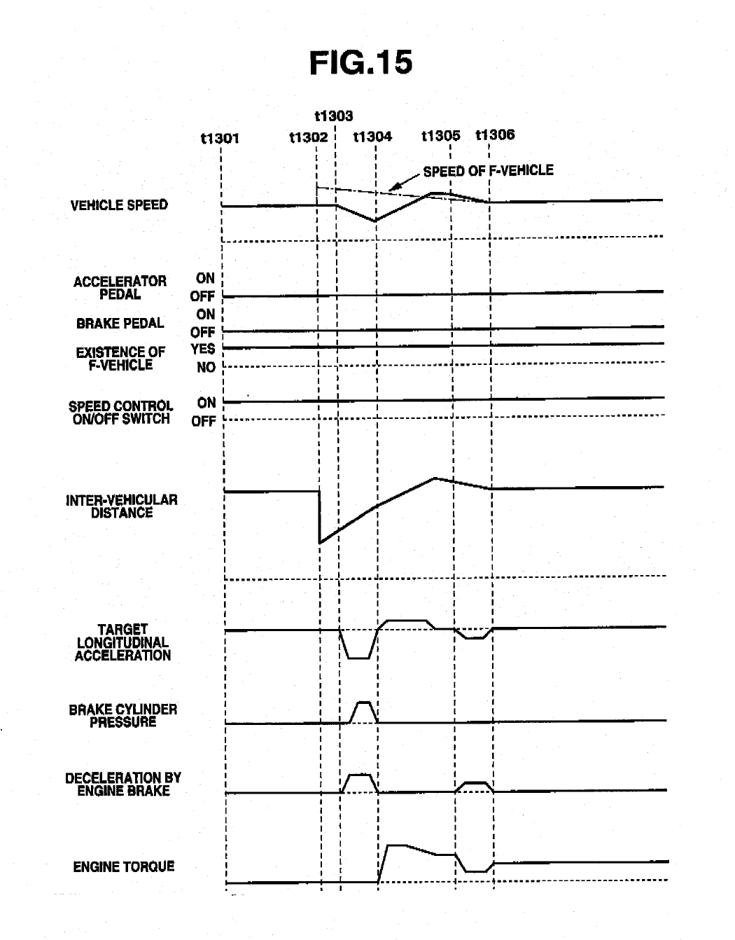

FIG. 15 is a time chart showing transition (or changes) of the various factors, that appears when under the speed control, a third vehicle gets into the space between a forward-vehicle and the own-vehicle.

At time point t1301, the own-vehicle runs with both the accelerator pedal and brake pedal kept OFF, and it has been kept judged a forward-vehicle is present in front of the own-vehicle. Thus, the speed control is kept. Until time point t1302, the own-vehicle runs at a fixed speed.

At time point t1302, the third vehicle gets into the space between the two vehicles, and thus the third vehicle becomes a new forward-vehicle in place of the old forward-vehicle. That is, the forward-vehicle changes. In the illustrated example, the speed of the new forward-vehicle is higher than the own-vehicle speed, which may be a phenomenon of reducing the possibility of a collision of the own-vehicle against the new forward-vehicle. However, in the illustrated example, since the current inter-vehicular distance “Dca” is smaller than the reference inter-vehicular distance “(Ttgt×Vi)”, the own-vehicle starts the deceleration at time point t1303.

At time point t1304, the current inter-vehicular distance “Dca” becomes larger than the reference inter-vehicular distance “(Ttgt×Vi)”, and thus, the own-vehicle starts acceleration.

At time point t1305, the current inter-vehicular distance “Dca” becomes smaller than the reference inter-vehicular distance “(Ttgt×Vi)”, and thus, the own-vehicle starts deceleration. At time point t1306, the speed of the new forward-vehicle and the own-vehicle speed become equal. After time point t1306, a target longitudinal acceleration is derived in accordance with a speed change of the forward-vehicle, and the own-vehicle is forced to run at a speed equal to the speed of the forward-vehicle.

In the following, various advantages of the speed control device of the present invention will be described.

(1) The vehicle speed control device of the invention comprises an accelerator pedal operation condition detecting means that detects an operation condition of an accelerator pedal, a brake pedal operation condition detecting means that detects an operation condition of a brake pedal, an inter-vehicular distance detecting means that detects a distance between an own-vehicle and a forward-vehicle, a speed control means that controls a speed of the own-vehicle, and a control unit that is configured to keep a relative positional relation between the own-vehicle and the forward-vehicle when the detected inter-vehicular distance is smaller than a predetermined reference inter-vehicular distance and the operation condition detected by the accelerator pedal operation condition detecting means and the brake pedal operation condition detecting means indicates a predetermined operation condition. Accordingly, in accordance with the accelerator pedal operation condition and the brake pedal operation condition, the relative positional relation between the forward-vehicle and the own-vehicle can be suitably controlled, and thus, “intervention by a driver” to the speed control is easily achieved. That is, the speed control device of the present invention allows a driver to easily and effectively make an intervention to the vehicle speed control when it is needed.

(2) For achieving the above-mentioned control, a brake control unit 102, an accelerator open degree sensor 110 and a master cylinder pressure sensor 104 are employed.

That is, when, by the accelerator open degree sensor 110 and/or the master cylinder pressure sensor 104, a reduction in depression degree of the accelerator pedal 109 or the brake pedal 103 is detected, the vehicle speed control that has been kept by the speed control means is interrupted. In other words, by assuredly detecting the operation condition of the accelerator pedal 109 or the brake pedal 103, the speed control of the own-vehicle is assuredly carried out in accordance with the will of the driver.

For much clearly describing the feature of the present invention, the following explanation will be provided.

That is, when, by the accelerator open degree sensor 110 and/or the master cylinder pressure sensor 104, the accelerator pedal 109 is moved in a so-called non-acceleration direction or the brake pedal 109 is moved in a so-called non-braking direction, the vehicle speed control that has been kept by the speed control means is interrupted.

When the accelerator pedal 109 is lifted due to reduction in a depression force applied to the pedal 109, the accelerator pedal degree sensor 110 senses the reduction in depression degree of the accelerator pedal 109, and when the brake pedal 103 is lifted due to reduction in a depression force applied to the pedal 103, the master cylinder pressure sensor 104 senses the reduction in depression degree of the brake pedal 103.

(3) With the aid of the forward-vehicle detecting camera 107 and the four wheel speed sensors 105a, 105b, 105c and 105d, the brake control unit 102 operates the speed control means in such a manner that the own-vehicle speed become equal to the speed of the forward-vehicle. Thus, even when the forward-vehicle is at a stop, the speed control applied to the own-vehicle is continued, which means increase in response speed of the speed control.

(4) The feedback control by the brake control unit 102 is so configured as to make the relative speed between the forward-vehicle and own-vehicle substantially 0 (zero). Thus, much assured speed control is realized by the own-vehicle as compared with the known distance-based forward-vehicle following control that uses the inter-vehicular distance as a base of the control.

(5) When a current distance “Dca” from the own-vehicle to the forward-vehicle is within the speed control executing range, a suitable information is given to the driver. With this, the driver can realize that the own-vehicle is under a speed control.

(6) The brake control unit 102 operates the speed control means to accelerate/decelerate the own-vehicle. With this, staffing of the speed control is assuredly recognized by the driver.

(7) With the aid of the four wheel speed sensors 105a, 105b, 105c and 105 by which the own-vehicle speed “Vi” is sensed, the brake control unit 102 sets the speed control executing range. Accordingly, the speed control executing range according to the own-vehicle speed “Vi” can be suitably set,

(8) With the aid of the forward-vehicle detecting camera 107 by which the speed of the forward-vehicle is detected and the four wheel speed sensors 105a, 105b, 105c and 105d by which the own-vehicle speed is detected, the brake control unit 102 sets the speed control executing range in accordance with the relative speed “Vr” between the two vehicles. Accordingly, the speed control executing range according to the relative speed “Vr” can be suitably set.

(9) Due to the function of the speed control means and the brake control unit 102, upon need of decelerating the own-vehicle, an engine braking is carried out before a speed reduction by the brakes. Thus, a so-called brake operation frequency is restrained, which brings about a longer-life of the brake system including the brake liquid pressuring unit 101.

(10) The vehicle speed control device of the invention comprises an acceleration pedal operation condition detecting means that detects a first situation in which a depression degree of an accelerator pedal is reduced, a brake pedal operation condition detecting means that detects a second situation in which a depression degree of a brake pedal is reduced, an inter-vehicular distance detecting means that detects a distance between a forward-vehicle and the own-vehicle, a brake means that is able to reduce a speed of a prime mover of the own-vehicle and a speed of road wheels of the own-vehicle, a forward-vehicle speed detecting means that detects a speed of the forward-vehicle, an own-vehicle speed detecting means that detects a speed of the own-vehicle and a control unit that is configured to operate the brake means to control a relative speed between the forward-vehicle and the own-vehicle when the first and second situations are detected and the detected inter-vehicular distance is smaller than a predetermined reference inter-vehicular distance. Accordingly, in accordance with the is acceleration pedal operation condition and the brake pedal operation condition, the relative positional relation between the forward-vehicle and the own-vehicle can be suitably controlled, and thus, the “intervention by a driver” to the speed control is easily carried out. That is, the speed control device of the invention allows a driver to easily and effectively make an intervention to the vehicle speed control when it is needed.

(11) When the distance “Dca” to the forward-vehicle is within the speed control executing range and both the accelerator pedal and brake pedal are turned to OFF condition, the speed control of the own-vehicle is so made as to keep a relative speed between the two vehicles in a given range, the relative speed being a speed that is exhibited when the accelerator pedal and brake pedal are turned to OFF condition. That is, the relative positional relation between the two vehicles can be controlled in accordance with the operation condition of the accelerator pedal and brake pedal, and thus, the “intervention by a driver” to the speed control is easily carried out.

(12) When the distance “Dca” to the forward-vehicle is put into the speed control executing range, a predetermined acceleration/deceleration is applied to the own-vehicle, which lets the drive know starting of the speed control.

(13) The speed control is so made that when the speed of the forward-vehicle is 0 (zero), the own-vehicle speed becomes 0 (zero). Thus, even when the forward-vehicle is at a stop, the speed control applied to the own-vehicle is continued, which means increase in response speed of the speed control.

In the following, modifications of the present invention will be described.

In the afore-mentioned speed control device of the invention, an engine is used for controlling the speed of the vehicle as well as driving the vehicle. If desired, in place of such is engine, an electric motor may be used as the means that controls the speed of the vehicle and drives the vehicle. That is, the speed control device of the invention is applicable to an electric motor vehicle as well as a hybrid car.

In the afore-mentioned speed control device of the invention, the speed control is started upon sensing OFF condition of the accelerator pedal and brake pedal. If desired, the speed control may be started upon sensing a reduction in depression degree of the accelerator pedal or the brake pedal.

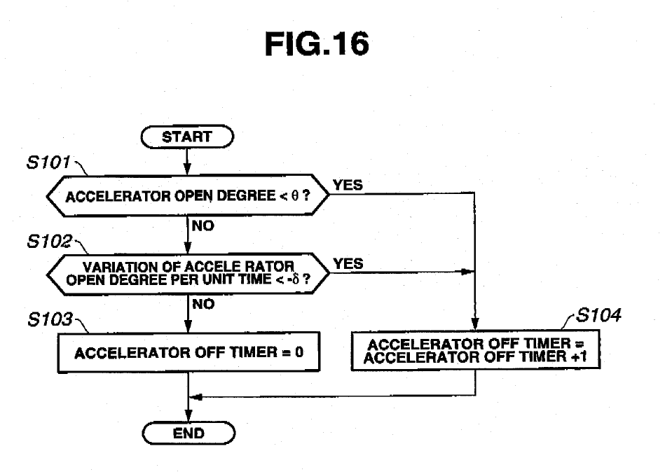

FIG. 16 is a flowchart depicting programmed operation steps executed for starting the speed control upon sensing a reduction in depression degree of the accelerator pedal. That is, the flowchart shows the programmed operation steps of an accelerator open degree discriminating logic.

At step S101, judgment is carried out as to whether an accelerator open degree is smaller than a predetermined degree e or not. If YES, that is, when the accelerator open degree is smaller than the predetermined degree θ, the operation flow goes to step S104, while, if NO, that is, when the accelerator open degree is equal to or larger than the predetermined degree θ, the operation step goes to step S102.

It is to be noted that the predetermined degree θ is a very small value near 0 (zero).

At step S102, judgment is carried out as to whether a variation of the accelerator open degree per unit time is smaller than a predetermined value −δ or not. If YES, that is, when the variation per unit time is smaller than the predetermined value −δ, the operation flow goes to step S104, while if NO, that is, when the variation per unit time is equal to or larger than the predetermined value −δ, the operation flow goes to step S103.

It is to be noted that the predetermined value −δ is a value that means establishment of the accelerator pedal OFF operation, viz., judgment of a release of driver's foot from the accelerator pedal.

It is further to be noted that the unit time is a calculation period for, for example, the above-mentioned target vehicle speed calculation process depicted by FIG. 5.

At step S103, an accelerator OFF timer is set to 0 (zero), and the control is finished.

At step S104, the accelerator OFF timer is subjected to increment (+1), and the control is finished.

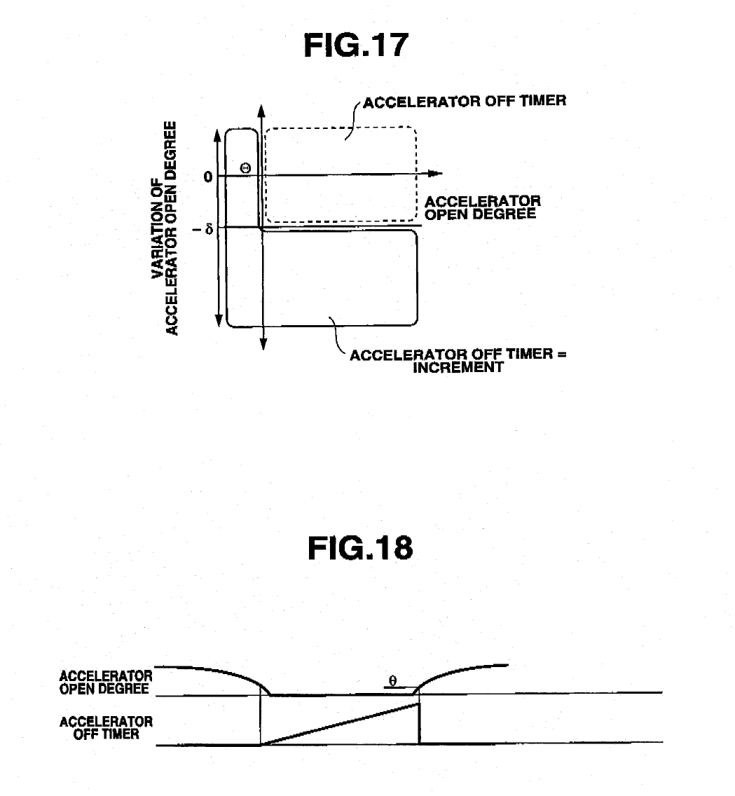

As is understood from the above, when, in the accelerator open degree discriminating logic, the accelerator open degree is 0 (zero) (viz., accelerator open degree<θ), or the variation of the accelerator open degree per unit time is smaller than the predetermined value −δ (viz., the variation is within a zone enclosed by a solid line in the graph of FIG. 17), it is judged that the driver has released his or her foot from the accelerator pedal (viz., accelerator OFF operation by the driver) and thus the accelerator OFF timer is subjected to increment. In other cases, that is, when the variation is within a zone enclosed by a broken line in the graph of FIG. 17, the accelerator OFF timer is set to 0 (zero).

As is seen from the graph of FIG. 18, when, for example, a driver releases the accelerator pedal to induce accelerator OFF condition, and then he or she depresses the accelerator pedal again, the accelerator OFF timer continuously increases the value from the time when the variation of the accelerator open degree per unit time becomes smaller than the predetermined value −δ to the time when the accelerator open degree becomes larger than to the predetermined degree θ. Thus, with the above-mentioned discriminating logic, judgment is so made that when the accelerator OFF timer shows a value other than 0 (zero), accelerator OFF operation is discriminated and the speed control is started.

For detecting a reduction in depression degree of the brake pedal, similar logic technique may be employed. That is, when the brake pedal depression degree that is derived from information signals from the master cylinder pressure sensor 104 or a brake pedal stroke sensor (not shown) is 0 (zero) or when a reduction amount (or decrement) of the brake pedal stroke per unit time is larger than a predetermined amount, it is judged that the driver has released his or her foot from the brake pedal, and a brake OFF timer is subjected to increment. When the brake OFF timer shows a value other than 0 (zero), brake OFF operation is discriminated, and the speed control is started.

In the above-mentioned speed control device, the speed control is so made as to make the relative speed between the two vehicles 0 (zero). However, if desired, the relative speed is controlled lower than a predetermined value. The predetermined value may increase with increase the own-vehicle speed.

In the above-mentioned speed control device, the camera 107 is employed for deriving the inter-vehicular distance. However, if desired, in place of such camera, a laser radar, a car navigation system and other known system may be employed.

The entire contents of Japanese Patent Application 2008-238153 filed Sep. 17, 2008 are incorporated herein by reference.

Although the invention has been described above with reference to the embodiment of the invention, the invention is not limited to such embodiment as described above. Various modifications and variations of such embodiment may be carried out by those skilled in the art, in light of the above description.

What is claimed is:

1. A vehicle speed control device of a motor vehicle with an accelerator pedal and a brake pedal, comprising:
an accelerator pedal operation condition detecting section that detects an operation condition of the accelerator pedal;
a brake pedal operation condition detecting section that detects an operation condition of the brake pedal;
an inter-vehicular distance detecting section that detects a distance between an own-vehicle and a forward-vehicle;
a speed control section that controls a speed of the own-vehicle; and
a control unit that is configured to keep a relative positional relation between the own-vehicle and the forward-vehicle when the detected inter-vehicular distance is smaller than a predetermined reference inter-vehicular distance and the operation condition detected by the accelerator pedal operation condition detecting section and the brake pedal operation condition detecting section indicates a predetermined operation condition.

2. A vehicle speed control device as claimed in claim 1, in which the control unit is configured to operate the speed control section when at least one of the accelerator pedal operation condition detecting section and the brake pedal operation condition detecting section detects a reduction in depression degree of the corresponding pedal.

3. A vehicle speed control device as claimed in claim 2, further comprising:
a forward-vehicle speed detecting section that detects a speed of the forward-vehicle; and
an own-vehicle speed detecting section that detects a speed of the own-vehicle,
wherein the control unit is configured to match the own-vehicle speed with the forward-vehicle speed.

4. A vehicle speed control device as claimed in claim 3, in which the control unit is configured to carry out a feedback control to make a relative speed between the two vehicles substantially 0 (zero).

5. A vehicle speed control device as claimed in claim 2, in which the control unit is configured to actuate an alarm device when the detected inter-vehicular distance reduces to the predetermined reference inter-vehicular distance.

6. A vehicle speed control device as claimed in claim 5, in which, upon reduction of the detected inter-vehicular distance to the predetermined reference inter-vehicular distance, the alarm device is actuated by the speed control section to decelerate the own-vehicle.

7. A vehicle speed control device as claimed in claim 2, further comprising:
an own-vehicle speed detecting section that detects a speed of the own-vehicle; and
a section that derives an inter-vehicular time that is a time needed by the own-vehicle to travel an inter-vehicular distance,
wherein the control unit is configured to set the predetermined reference inter-vehicular distance based on both the detected speed of the own-vehicle and the inter-vehicular time.

8. A vehicle speed control device as claimed in claim 2, further comprising:
a forward-vehicle speed detecting section that detects a speed of the forward-vehicle; and
an own-vehicle speed detecting section that detects a speed of the own-vehicle,
wherein the control unit is configured to set the predetermined reference inter-vehicular distance based on a relative speed between the two vehicles.

9. A vehicle speed control device as claimed in claim 2, in which the speed control section comprises:
an engine that is mounted on the own-vehicle to power the vehicle; and
a hydraulic brake system that operates to feed a pressurized fluid to brake cylinders of road wheels of the vehicle to brake the vehicle,
wherein the control unit is configured to induce an engine brake of the engine prior to starting the hydraulic brake system upon need of deceleration of the own-vehicle.

10. A speed control device of a motor vehicle with an accelerator pedal and a brake pedal, comprising:
an accelerator pedal operation condition detecting section that detects a first situation in which a depression degree of the accelerator pedal is reduced;
a brake pedal operation condition detecting section that detects a second situation in which a depression degree of the brake pedal is reduced;
an inter-vehicular distance detecting section that detects a distance between a forward-vehicle and the own-vehicle,
a brake section that is able to reduce a speed of a prime mover of the own-vehicle and a speed of road wheels of the own-vehicle;
a forward-vehicle speed detecting section that detects a speed of a forward-vehicle;
an own-vehicle speed detecting section that detects a speed of the own-vehicle;
a speed control section that controls a speed of the own-vehicle; and
a control unit that is configured to control operation of the prime mover and that of the brake section to control a relative speed between the two vehicles when at least one of the accelerator pedal operation condition detecting section and the brake pedal operation condition detecting section detects a reduction in depression degree of the corresponding pedal and the detected inter-vehicular distance is smaller than a predetermined reference inter-vehicular distance.

11. A vehicle speed control device as claimed in claim 10, in which the control unit is configured to operate the speed control section to match the own-vehicle speed with the forward-vehicle speed.

12. A vehicle speed control device as claimed in claim 11, in which the control unit is configured to carry out a feedback control to make a relative speed between the two vehicles substantially 0 (zero).

13. A vehicle speed control device as claimed in claim 10, in which the control unit is configured to actuate an alarm device when the detected inter-vehicular distance reduces to the predetermined reference inter-vehicular distance.

14. A vehicle speed control device as claimed in claim 13, in which, upon reduction of the detected inter-vehicular distance to the predetermined reference inter-vehicular distance, the alarm device is actuated by the speed control section to decelerate the own-vehicle.

15. A vehicle speed control device as claimed in claim 10, in which the control unit is configured to set the predetermined reference inter-vehicular distance based on the detected speed of the own-vehicle and an inter-vehicular time, the inter-vehicular time being a time needed by the own-vehicle to travel the inter-vehicular distance.

16. A vehicle speed control device as claimed in claim 10, in which the control unit is configured to set the predetermined reference inter-vehicular distance based on a relative speed between the two vehicles.

17. A vehicle speed control device as claimed in claim 10, in which the control unit is configured to induce an engine brake of the engine prior to starting the hydraulic brake system upon need of deceleration of the own-vehicle.

18. A method of controlling a speed of a motor vehicle that has an accelerator pedal, a brake pedal and a speed control section, comprising in steps:
detecting an operation condition of the accelerator pedal;
detecting an operation condition of the brake pedal;
detecting an inter-vehicular distance between an own-vehicle and a forward-vehicle; and
keeping a relative positional relation between the two vehicles when the detected inter-vehicular distance is smaller than a predetermined reference inter-vehicular distance and the detected operation condition of the accelerator pedal and the brake pedal indicates a predetermined operation condition.

19. A method as claimed in claim 18, in which when the detected inter-vehicular distance becomes smaller than the predetermined reference inter-vehicular distance, deceleration is applied to the own-vehicle.

20. A method as claimed in claim 19, in which when the speed of the forward-vehicle becomes 0 (zero), deceleration is applied to the own-vehicle to stop the own-vehicle.
